(19) United States
(12) Patent Application Publication
(10) Pub. No.: US 2015/0277841 A1
(43) Pub. Date: Oct. 1, 2015

(54) MULTI MODE DISPLAY SYSTEM

(71) Applicant: Microsoft Corporation, Redmond, WA (US)

(72) Inventors: Jaron Lanier, Berkeley, CA (US); Joel S. Kollin, Seattle, WA (US); William T. Blank, Bellevue, WA (US); Douglas C. Burger, Bellevue, WA (US); Patrick Therien, Bothell, WA (US)

(73) Assignee: Microsoft Corporation, Redmond, WA (US)

(21) Appl. No.: 14/228,110

(22) Filed: Mar. 27, 2014

(51) Int. Cl. G06F 3/14; G09G 5/14; G02B 27/01; G09G 5/00

(52) U.S. Cl. CPC G06F 3/1431; G09G 5/003; G09G 5/14; G02B 27/0101; G09G 2354/00; G09G 2360/04; G09G 2340/0407; G02B 2027/014; G02B 2027/0147

(57) ABSTRACT

Embodiments relating to a multi-mode display device are disclosed. For example in one disclosed embodiment a multimode display device includes a principal and a secondary image display mounted in a common housing configure to alternately emit light through a common transparent region in the viewing surface. The multimode display device is configured to display a first image on the principal image display at a first resolution or display a second image on the secondary image display of higher resolution than the first image and on a virtual plane behind the viewing surface of the display device. The multi-mode display device is configured to compare the a detected eye relief distance to a predetermined threshold and display the image on the appropriate image display and set the other image display to a non-display state.

### BACKGROUND

Wearable computing devices, such as smart watches, offer users the ability to take computing devices with them when on the go, without requiring users to grasp a device such as a smart phone or tablet, thus keeping the users' hands free. These devices hold the promise of enhancing activities such as walking, hiking, running, etc. However, one challenge with current wearable computing devices is that their displays are relatively small, and the content that can be displayed to a user is thus limited.

One prior approach to address a similar challenge in smartphone design has been to increase the size of the display to that of the form factor known as a “phablet,” a portmanteau of the words “phone” and “tablet”. However, for wearable computing devices such a large display will result in a corresponding decrease in compactness and portability, potentially interfering with activities such as walking, hiking, and running discussed above. Another prior approach used in smartphone design has been to provide pinch zooming/scrolling functionality in a user interface. However, performing such gestures on a small display such as a smart watch is much more difficult and the user's fingers may occlude the entire display during the gesture. Further, such gestures provide for detailed viewing of only a portion of the available display content. As a result, barriers exist to the ease of use of such wearable computing devices and their adoption has not yet become mainstream.

### SUMMARY

Embodiments relating to a multi-mode display device are disclosed. For example, in one disclosed embodiment a multimode display device includes a principal and a secondary image display mounted in a common housing configure to alternately emit light through a common transparent region in the viewing surface. The multimode display device is configured to display a first image on the principal image display at a first resolution or display a second image on the secondary image display of higher resolution than the first image and on a virtual plane behind the viewing surface of the display device. The multi-mode display device is configured to compare a detected eye relief distance to a predetermined threshold and display the image on the appropriate image display and set the other image display to a non-display state.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a multi-mode display system according to an embodiment of the present disclosure.

FIG. 2 is a schematic view of a user viewing the multi-mode display system of FIG. 1, at a first distance from the user.

FIG. 3 is a schematic view of a user viewing the multi-mode display system of FIG. 1 at a second, different distance from the user.

FIG. 4 is a schematic view of a first embodiment of a display stack of the multi-mode display system of FIG. 1.

FIG. 5 is a schematic view of second embodiment of a display stack of the multi-mode display system of FIG. 1.

FIG. 6 is a schematic view of a third embodiment of a display stack of the multi-mode display system of FIG. 1.

FIG. 7 is a schematic view of a wearable embodiment of the multi-mode display system of FIG. 1.

FIG. 8A and 8B are a flowchart of a multi-mode display method according to an embodiment of the present disclosure.

FIG. 9 is a simplified illustration of a computing device according to an embodiment of the present disclosure.

### DETAILED DESCRIPTION

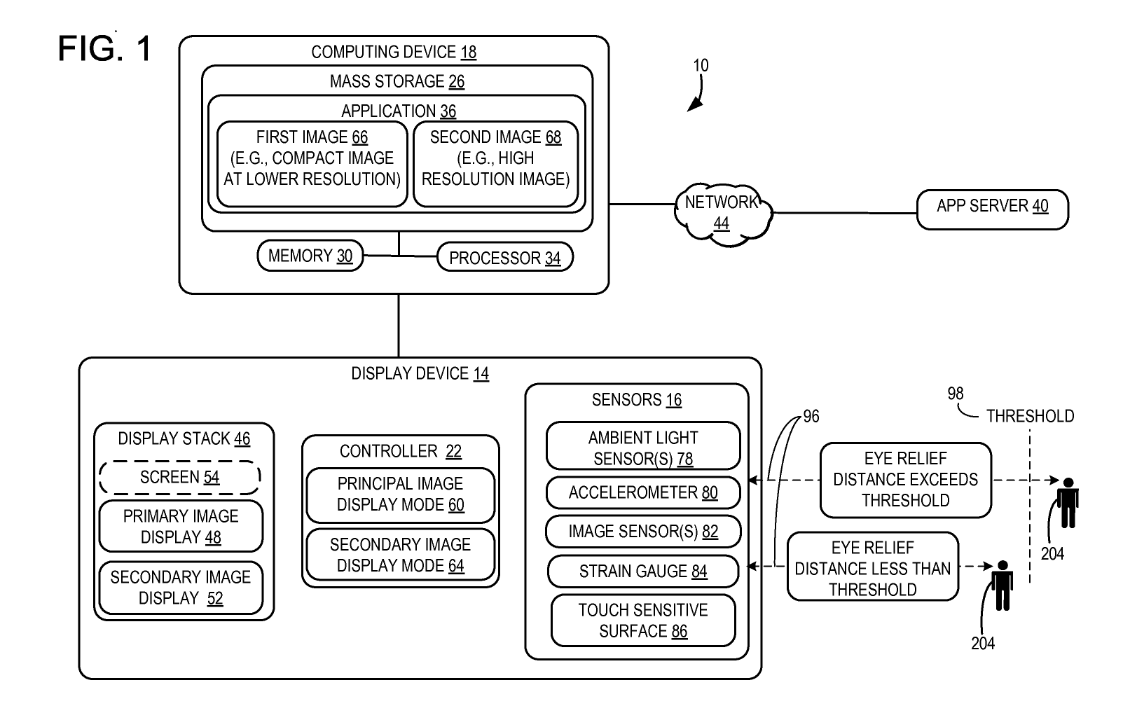

FIG. 1 shows a schematic view of one embodiment of a multi-mode display system 10 according to an embodiment of the present disclosure. The multi-mode display system 10 comprises a multi-mode display device 14 that is configured to operate both as a near eye display and as a distant display and accordingly to display a different image to the user in each of these modes, depending on an estimated or detected eye relief distance to the user's eye. In some examples described in more detail below, the multi-mode display device 14 may be embedded in a wearable design or other compact form factor.

The display device 14 may be operatively connected to a computing device 18, as shown. Display device 14 is typically configured to receive an image source signal encoding a display image from computing device 18, and to display the display image on the screen 54 of display stack 46. The display device may connect via a wired or wireless connection to the computing device 18 to receive the image source signal. Alternatively or in addition, the display device 14 may be configured with an on-board image source under the control of an on-board processor, such as controller 22 described below.

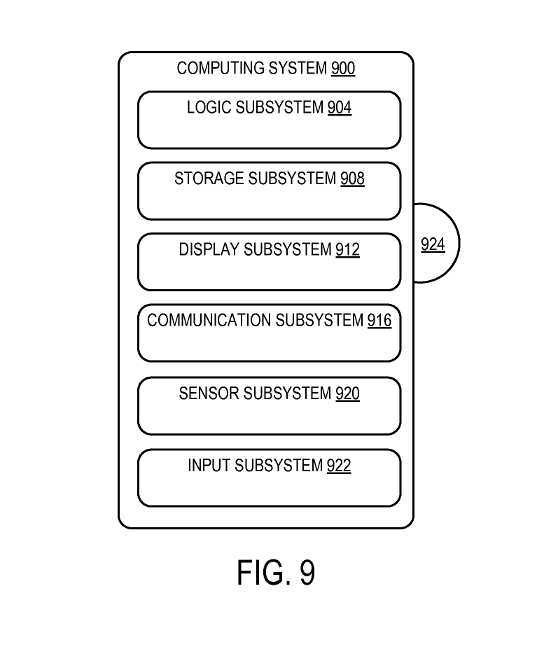

Computing device 18 typically includes a processor 34 configured to execute an application program 36 stored in a non-volatile manner in mass storage 36, using portions of memory 30. The application program 36 is configured to programmatically generate output for display on the display device 14, including the first image 66 and second image 68, which may be encoded in the above described image source signal that is sent to the display device 14. For reasons that will become apparent below, the first image is typically a compact image of comparatively low resolution and the second image is typically a larger image of a higher resolution than the first image. The application program 36 may communicate with an application server 40 via a network 44, such as the Internet, and may retrieve information used to generate the output that is displayed on display device 14 from application server 40, or other devices such as a peer device, etc. It will be appreciated that additionally or in the alternative, the display device 14 may be equipped with wired or wireless networking hardware that enables it to communicate directly with the application server 40 to download and display output such as the first image 66 and second image 68. Additional details regarding the components and computing aspects of the multi-mode display system 10 are described in more detail below with reference to FIG. 9.

To address the challenges discussed in the Background above, the multi-mode display device 14 may include a controller 22 configured to switch between one of two display modes, a principal image display mode 60 in which a user may view the display device 14 from afar, and a secondary image display mode 64 in which the user may view the display device 14 from close up, offering the user access to a more detailed display of information. To achieve these display modes, display device 14 includes a display stack 46 with specially designed optics. Display stack 46 typically includes a principal image display 48 configured to display the first image 66 at a first resolution in the principal image display mode 60, and a secondary image display 52 configured to display a second image 68 of higher resolution than the first resolution of the first image 66 in the secondary image display mode 64. The light forming the images respectively displayed by primary image display 48 and secondary image display 52 is typically emitted through the same screen 54, which as described below may be a transparent region in a viewing surface of a housing of the display device 14.

To facilitate the switching between the principal image display mode 60 and the secondary image display mode 64, the controller 22 may receive signals from one or more sensors 16, and make a determination of an eye relief distance between the viewing surface of the display device and the eye of a user, and based on the determined eye relief distance, switch between the principal image display mode 60 and the secondary image display mode 64.

Sensors 16 are collectively referred to as eye relief sensors since they are used by the controller to make an eye relief distance determination; however, it will be appreciated that the output of the sensors may be used by the display device for other purposes as well, and that they may not be exclusively used to determined eye relief. Each of sensors 16 detects a parameter, referred to as an eye relief distance parameter, which is used by the controller to the controller 22 to determine an eye relief distance eye relief distance between the display device 14 and an eye of the user. Typically, the eye relief distance is measured from the viewing surface of the display device to the eye of the user. In some embodiments, the multi-mode display device 14 may include a single eye relief sensor, while in others, a plurality of eye relief sensors may be used to determine the eye relief distance.

The eye relief sensors may include one or more of an image sensor 82, an ambient light sensor 78, an accelerometer 80, a strain gauge 84, and a capacitive touch-sensitive surface 86. The image sensor 82 may, for example, be a camera, a pair of cameras, etc. configured to capture images of a scene including the user's eyes. Image recognition algorithms may be employed to calculate the eye relief distance based upon a detected interpupillary distance between the user's pupils in the captured images, for example. In some embodiments the image sensor 82 may be a depth camera. In other embodiments, a pair of cameras may be utilized to enable stereoscopic imaging techniques that can be used to provide an estimate of the distance to a point in the images recognized as the user's eye. In some cases, the eye relief distance may be determined for each eye of the user, and the two distances may be averaged and compared against the threshold 98.

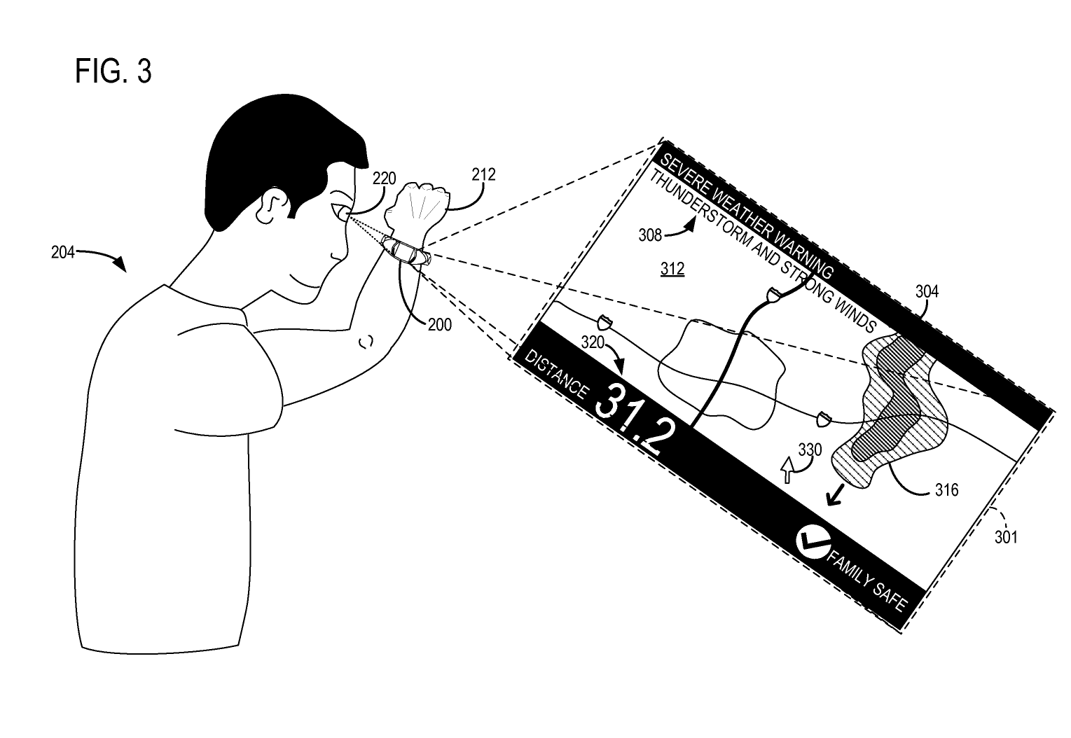

In addition or in the alternative to the image sensors 82, data from the accelerometer 80 and data from the ambient light sensor(s) 78 may be used to determine a distance between display device 14 and an eye of the user. This may be particularly useful, for example, when the display device 14 includes a housing that is constructed in the form factor of a wearable computing device such as a wristwatch 200, as depicted in FIG. 3. The eye relief sensor (such as ambient light sensor 78), principal and secondary image displays accelerometer, etc. may be incorporated into the housing. As the user 204 raises his wrist to bring wristwatch 200 closer to his eye 220, the accelerometer 80 may detect a signature acceleration that is associated with such movement. Additionally, as the ambient light sensor 78 of wristwatch 200 moves closer to the user's eye 220 and face, the ambient light level detected by the ambient light sensor 78 may correspondingly decrease. For example, when the wristwatch 200 is located less than the predetermined threshold from the user's eye 220, the ambient light detected by an ambient light sensor 78 facing the user's face may be less than a predetermined percentage of the overall ambient light of the surrounding environment, as determined from previous measurements of the ambient light sensor when the wristwatch was not positioned proximate the user's face, or as determined from an ambient light sensor facing away from the user's face, etc.

When the accelerometer 80 detects the signature acceleration of the wristwatch 200 and the ambient light sensor 78 detects that the ambient light level decreases below the predetermined percentage, the controller 22 may determine that the wristwatch 200 has been moved to a position that is less than the predetermined distance from the user's eye 220. Alternatively expressed, when the combination of a signature acceleration and an ambient light level decreasing below a predetermined percentage is determined to exist, the wristwatch 200 may be determined to have been moved to a position that is less than the predetermined threshold eye relief distance from the user's eye 220. As described above, upon making such a determination, the controller 22 may then switch between the first display mode 60 and the second display mode 64.

In some examples, a temporal relationship of the signature acceleration and threshold ambient light level may also be utilized to make the eye relief distance determination. An example of such a temporal relationship is that each condition is to be satisfied within a predetermined time period such as, for example, 1.0 seconds, as a further condition of determining that the wristwatch 200 has been moved to a position that is less than the predetermined distance from the user's eye 220.

In other examples, the display device 14 may include an inertial measurement unit (IMU) that utilizes the accelerometer 80 and one or more other sensors to capture position data and thereby enable motion detection, position tracking and/or orientation sensing of the display device. The IMU may also be receive input data from other suitable positioning systems, such as GPS or other global navigation systems, and factor that input into its own determination of the position and orientation of the display device 14. This may increase the positional accuracy of the IMU measurements when these other systems are operational and receiving position detection signals by which position may be ascertained.

Strain gauge 84 may be configured to measure the strain, bend and/or shape of a band, such as a wristband, associated with the display device. In the example of wristwatch 200 shown in FIG. 7, the strain gauge 84 may be located in one or both of band portions 716 and 718. In some examples, the strain gauge 84 may comprise a metallic foil pattern supported by an insulated flexible backing. As the user 204 moves and/or flexes his hand 212, the band portions 716, 718 and integrated foil pattern are deformed, causing the foil's electrical resistance to change. This resistance change is measured and a corresponding strain exerted on the band portions 716, 718 may be determined.

Advantageously and as explained in more detail below, the strain gauge 84 may be utilized to detect one or more motions of the user's hand 212 and correspondingly receive user input. For example, hand movement side-to-side or up and down may be sensed via the corresponding tensioning and relaxation of particular tendons within the wrist area. In some examples, changes in the overall circumference of the user's wrist may be detected to determine when the user is making a fist. Each of these movements may be correlated to a particular user motion that may effect a change in eye relief distance. It will also be appreciated that any suitable configuration of strain gauge 84 may be utilized with the wristwatch 200 or other form factor that display device 14 may assume.

Touch-sensitive surface 86 may be a single or multi-touch sensitive surface, typically integrated with display screen 54 to function as a touch sensitive display, which is configured to receive single or multi-touch user input. In one embodiment, the touch sensitive surface is a capacitive touch sensitive surface that is configured to detect the presence of a body part of the user, such as the user's face, coming within the predefined threshold 98, by measuring changes in capacitance that are caused by the approach of the face to the touch sensitive surface. Such an input may be fed to controller 22 to further aid the controller in its determination of whether the eye relief distance is less than the predetermined threshold 98.

Based on the inputs from the various sensors 16 described above, controller 22 is configured to determine if the eye relief distance 96 exceeds a predetermined threshold 98. Upon determining that the eye relief distance 96 exceeds the predetermined threshold 98, the controller 22 is configured to cause the display of the first image 66 on the principal image display 48 and set the secondary image display 52 to a non-display state. Conversely, under other conditions, the controller 22 is configured to determine that the eye relief distance 96 is less than the predetermined threshold 98, and upon determining that the eye relief distance is less than the predetermined threshold 98, display the second image 68 on the secondary image display 52 and set the principal image display 48 to the non-display state. Since the two displays share an optical path that passes through the transparent region of the viewing surface of display screen 54, it will be appreciated that both screens typically cannot be illuminated at the same time and still be properly viewed by the user. Further doing so would consume precious power resources in wasteful manner. For these reasons, the primary and secondary displays 48, 52 are alternately turned to the non-display state in accordance with operating conditions.

In one use case scenario, when the display device 14 is located at a first eye relief distance greater than the threshold 98 from the user, the display device 14 may display an instance of the first image 66 of a relatively lower display resolution that conveys a summary version of visual information from application program 36. When a user moves the display device 14 to a second eye relief distance 96 less than the threshold 98 from the user, the display device 14 may switch to display an instance of the second image 68 that is of a higher display resolution, and thus which comprises a second, greater amount of visual information from the application program 36. As illustrated in FIG. 3 and discussed further below, when the user is less than the threshold eye relief distance from the device, the optics of the secondary image display 52 of the display stack 46 are configured to display the second image 68 on a virtual plane 301 located behind the screen 54 display of the display, allowing the user's eye to focus on the second image 68.

To switch between the two display modes, controller 22 may be further configured to determine a change in the detected eye relief distance from an eye relief distance 96 greater than the predetermined threshold 98 to an eye relief distance 96 less than the predetermined threshold 98, and display the second image 68 on the secondary image display 52 and cease display of the first image 66 on the principal image display 48 and set the principal image display 48 to a non-display state. Controller 22 may also be further configured to determine a change in the detected eye relief distance 96 from less than the predetermined threshold 98 to a detected eye relief distance greater than the predetermined threshold 98 and display the first image 66 on the principal image display 48 and cease display of the second image 68 on the secondary image display 52 and set the secondary image display 52 to a non-display state.

Thus, when a user brings the display device 14 closer to the user's eyes to an eye relief distance less than the predetermined threshold 98, the controller 22 may be configured to switch from the lower resolution image of the principal image display mode 60 and to the higher resolution image of the secondary image display mode 64. To achieve this, in the secondary image display mode 64, the principal image display 48 is set to a non-display state and the secondary image display 52 is activated to display a second application image 68 that has a second, greater display resolution (as compared to the first compact image 58) and that also us from application program 36. Advantageously and as explained in more detail below, in this manner the multi-mode display system 10 facilitates quick and convenient user access to and navigation among varying amounts of visual information from application program 36.

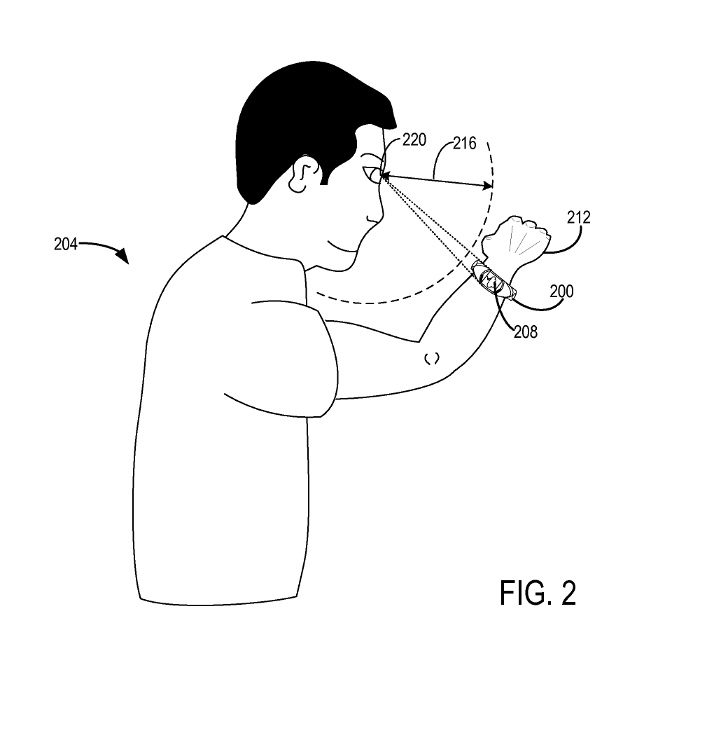

FIGS. 2, 3, and 7 illustrate an embodiment of the multi-mode display system 10 that has a form factor of a wristwatch 200 removably attachable to a wrist area adjacent a hand 212 of user 204. As shown in FIG. 2, when the wristwatch 200 is detected to be more than a predetermined eye relief distance 216 from an eye 220 of the user 204, the principal image display mode 60 is engaged. The predetermined threshold 98 for the eye relief distance may be a distance selected in a range between about 20 millimeters (mm) and 180 mm. In other examples, the predetermined threshold 98 may be between about 40 mm and 160 mm, between about 60 mm and 140 mm, between about 80 mm and 120 mm, or may be about 100 mm.

In one example use case scenario as illustrated in FIG. 7, the wristwatch 200 in the principal image display mode 60, i.e., distant eye mode, displays a weather tile image 712 from a weather application program that indicates a severe weather warning as the compact image 208. The weather tile image 712 is displayed at a first, lower, display resolution that presents a quickly recognizable icon of a thundercloud and lightning bolt along with an exclamation point. The user 204 is shown in FIG. 2 glancing at the wristwatch 200 from beyond the predetermined eye relief distance, from which vantage the user can promptly discern the weather warning imagery in the compact image 208 and thereby determine that a severe weather event may be imminent.

With reference now to FIGS. 2 and 3 and to quickly obtain additional information regarding the weather event, the user 204 may raise his hand 212 and wristwatch 200 closer to his eyes 220 such that the wristwatch 200 is less than the predetermined threshold 98 for the eye relief distance from the user's eyes. As noted above, when the wristwatch 200 is detected at eye relief distance less than the predetermined threshold 98, the controller 22 triggers the secondary image display mode 64, i.e., the near eye display mode. In this example, the secondary image display mode 60 utilizes the secondary image display 52 of the wristwatch 200 to display an application image in the form of a graphical user interface 304 of the weather application program on a virtual plane 301 at a perceived distance from the user 204. Additional details regarding the secondary image display 52 are provided below.

By comparing FIGS. 3 and 7, it will be apparent that the application image in the form of graphical user interface 304 has a second display resolution that presents a greater amount of visual information corresponding to the weather application program than the first display resolution of the compact image 208 in the form of the weather tile image 712. In the example of FIGS. 3 and 7, and as explained in more detail below, the weather application program graphical user interface 304 includes a weather detail region 308 that notes that the warning relates to a thunderstorm and strong winds, a map region 312 that includes a radar image of a storm 316, a distance region 320 indicating a distance of the storm 316 from the user's current location, and a family status region 324 providing a status update regarding the user's family. Advantageously, the graphical user interface 304 provides the user 204 with a quickly and conveniently accessible, high resolution application image that provides a large-screen user experience containing significant visual information. It will be appreciated that the weather tile image is but one example of a type of compact image that may be displayed, and that any suitable content and design of compact image and application image may be utilized.

By way of illustration of the differences between the resolutions of the application image and the compact image, in one embodiment the compact image may be 320 by 320 pixels in resolution, and the application image may be displayed at 768×1280, 720 by 1280, 1080 by 1920, or higher resolutions. It will be appreciated that other resolutions may also be utilized.

The multi-mode display device 14 may include a housing 701 with a transparent region in the viewing surface 703 to allow the light emitted from the principal image display 48 and secondary image display 52 mounted within the housing 701 to pass through to the user. Typically, the principal and secondary image displays 48, 52 are configured to alternately emit light through the transparent region of the viewing surface, and one is turned to a non-display state when the other is in a display state, as discussed above. The transparent region of the viewing surface is also referred to herein as the display screen 54. Thus, the light emitted from both of the primary image display and the secondary image display is emitted through display screen 54.

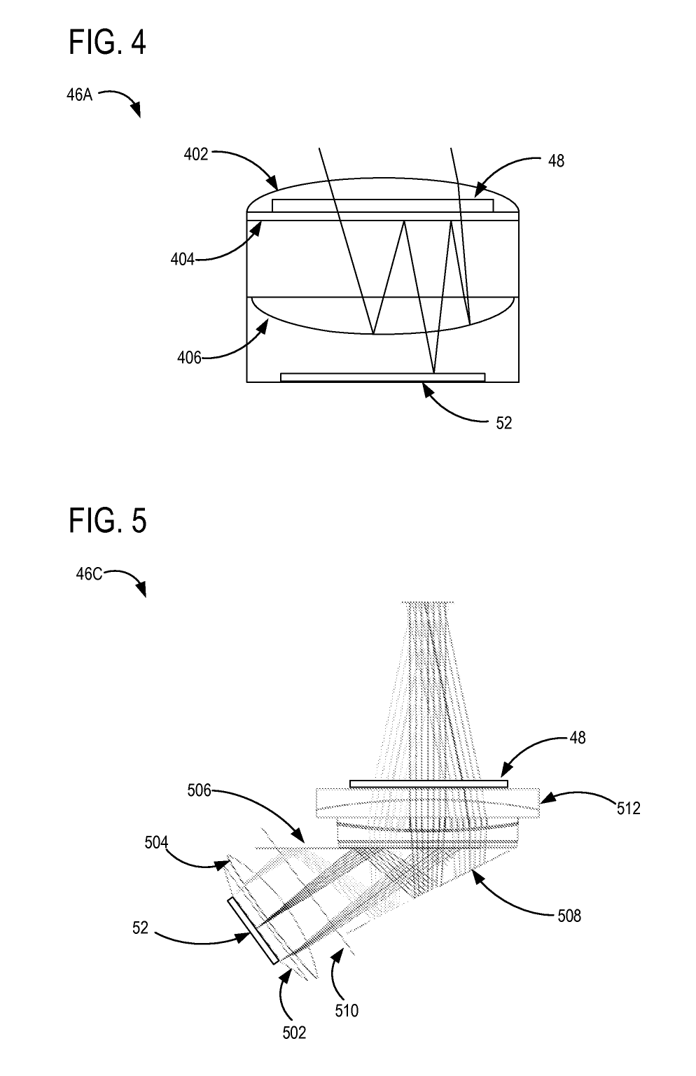

The display optics of the display device 14 will now be discussed in detail. With reference now to FIG. 4, a schematic representation of a first embodiment of display stack 46A of display device 14 is shown. Display stack 46A includes the principal image display 48 and the secondary image display 52. In display stack 46A, the principal image display 48 is positioned on a light emitting side of the secondary image display 52. The principal image display 48 includes an optically transparent light emitting display, and the transparent region in the viewing surface is formed to include a simple magnifier 402. The simple magnifier 402 consists of a converging lens to direct the light from either image display to the eye of the user. As shown, a partially-reflective, curved magnifier 406, a reflective polarizer 404, and the principal image display 48 are all positioned on a light emitting side of the secondary image display 52. The display stack 46 is further configured such that the partially reflective, curved magnifier 406 is positioned to substantially collimate light emitted from the secondary image display 52 and the partially-reflective, curved magnifier 406 and reflective polarizer 404 are positioned between the principal image display 48 and secondary image display 52 with a concave surface of the partially-reflective curved magnifier 406 being oriented toward the reflective polarizer 404. The partially-reflective, curved magnifier 406 may also comprise a second reflective polarizer or any other suitable reflective material. With display stack 46A, light emitted from the secondary image display 52 is reflected toward the partially-reflective, curved magnifier 406 by the reflective polarizer 404. Partially-reflective, curved magnifier 406 then reflects the light back toward the reflective polarizer 404. The reflected light may then pass through the reflective polarizer 404, through the principal image display 48 and a subsequent simple magnifier 402 and then to the user's eye. The reflective polarizer 404 and the partially-reflective, curved magnifier 406 function to increase the length of the optical path of light emitted by the secondary image display 52 allowing for the generation of a higher resolution image, i.e., the second image, to be displayed on the virtual plane 301, shown in FIG. 7, which is located a distance behind a viewing surface 703 and behind the secondary image display 52 of the display device 14.

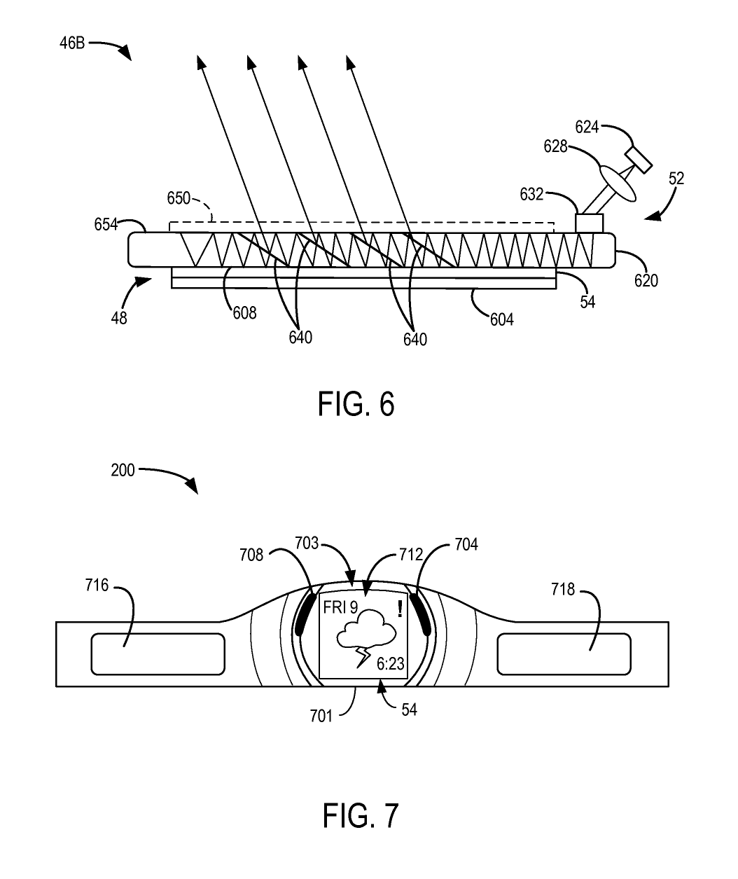

Turning now to FIG. 6, a second embodiment of the display stack 46B is shown in a layered configuration in which a first display technology for the principal image display 48 and a second, different display technology for the secondary image display 52 are utilized in a sandwiched configuration. In FIG. 6, the secondary image display 52 is positioned on a light emitting side of the principal image display 48, and the secondary image display 52 includes an optically transparent light emitting display.

Continuing with FIG. 6, the principal image display 48 may comprise a diffusive display such as a luminescent or reflective liquid crystal display (LCD), or any other suitable display technology. The principal image display 48 may comprise an innermost layer of the display stack 46, and may include a display screen 54 positioned on a light emitting component 604. As noted above, the principal image display 48 may be configured to display one or more compact images via the display screen 54.

The secondary image display 52 is positioned on the light emitting side 608 of the principal image display 48. As noted above and shown in FIG. 3, the secondary image display 52 is configured to display images on a virtual plane at a perceived distance behind the display stack 46 as viewed from the user's eye 220. In one example, the secondary image display 52 may comprise a side addressed transparent display that enables a near-eye viewing mode. In such a near-eye display system, the user perceives a much larger, more immersive image as compared to an image displayed at the display screen 54 of the principal image display 48.

As shown in FIG. 6, the principal image display 48 is a first light emitting display, and the secondary image display 52 includes a second light emitting display and an optical waveguide configured to guide light from the second light emitting display to a series of exit gratings formed within the waveguide. A micro-projector 624, such as an Organic Light Emitting Diode (OLED) display, may project light rays comprising an image through a collimator 628 and entrance grating 632 into the waveguide structure 620. In one example, partially reflective exit gratings 640 located within the waveguide structure 620 may reflect light rays outwardly from the structure and toward the user's eye 220. In another example, and instead of the partially reflective exit gratings 640 within the waveguide structure 620, a partially reflective exit grating 650 that transmits light rays outwardly from the waveguide structure 620 toward the user's eye 220 may be provided on a light emitting side 654 of the waveguide structure 720.

Additionally, the waveguide structure 620 and exit grating(s) may embody a measure of transparency which enables light emitted from the principal image display 48 to travel through the waveguide structure and exit grating(s) when the micro-projector 624 is deactivated (such as when the principal image display mode 60 is active). Advantageously, this configuration makes two displays and two display resolutions available to the user through the same physical window.

In other examples, a display stack having a sandwiched configuration may include a lower resolution, principal image display on a top layer of the stack and a higher resolution, secondary image display on a bottom layer of the stack. In this configuration, the principal image display is transparent to provide visibility of the secondary image display through the stack. In some examples, the principal image display may comprise a transparent OLED display or any other suitable transparent display technology.

As noted above, when the display device 14 and display stack 46 are greater than a threshold eye relief distance from the user 96, the first display mode 60 may be utilized in which the principal image display 48 is activated and the secondary image display 52 is set to a non-display state by controller 22. In the principal display mode 60 and with reference to the example display stack 46 of FIG. 6, the principal image display 48 may display a compact image 58 that is viewable through the transparent secondary image display 52. When a user brings the display device 14 and display stack 46 to a position less than the threshold eye relief distance 98 from the user, the controller 22 may switch between the first display mode 60 and the second display mode 64. More particularly, the controller 22 may set the principal image display 48 to a non-display state and activate the secondary image display 52.

It will also be appreciated that optical systems may be utilized that feature folded optical paths. For example, an optical path having a single fold, double fold, triple fold or higher numbers of folds may be utilized. FIG. 5 schematically illustrates a third embodiment of a display stack 46C, having a folded optical path in which the principal image display 48 is positioned on a light emitting side of the secondary image display 52. The light from the secondary image display 52 is directed through an optical light path comprising one or more reflective surfaces and one or more lenses. The one or more reflective surfaces and one or more lenses create a folded light path for the display of the virtual image.

Specifically, the optical path of the embodiment of FIG. 5 is as follows. Light emitted from secondary image display 52 is focused by a first lens 502 and a second lens 504. The light is then reflected off of first reflector 506 onto second reflector 508. Second reflector 508 directs the light toward a flapjack magnifier assembly 512. Within the flapjack magnifier assembly 512, the light passes through a series of reflective magnifiers before leaving flapjack magnifier assembly 512. The light then passes through the principal image display and on to the user's eye. Flapjack magnifier assembly 512 also functions as a converging lens directing the light emitted toward a focal point some distance from the viewing surface of the multi-mode display. A third reflector 510 prevents light escape from the folded optical path.

It will be further appreciated that the principal and secondary image displays 48, 52 may be either opaque or transparent in the non-display state dependent on the configuration of the display stack. In display stack 46A of FIG. 4 and display stack 46C of FIG. 5, the uppermost display, i.e., the principal image display 48 is transparent in the non-display state so as not to obscure the visibility of the underlying image display, i.e., the secondary image display 52. Conversely, in these embodiments the secondary image display 52 is typically opaque in the non-display state to enhance the contrast of the image displayed by the overlying image display, although it may also be set to be transparent. In the embodiment of FIG. 6, the principal image display 48 is typically opaque in the non-display state to improve the contrast and visibility of the secondary image display 52. Alternatively, the principal image display in this embodiment may be opaque. Further, the secondary image display 52 in this embodiment is typically transparent in the non-display state.

The principal image display 48 and secondary image display 52 have been described above as including light emitting displays, a term meant to encompass both displays with display elements that directly emit light such as light emitting diodes (LEDs) and OLEDs, discussed above, and those that modulate light such as liquid crystal displays (LCDs), liquid crystal on silicon displays (LCoS), and other light modulating display technologies.

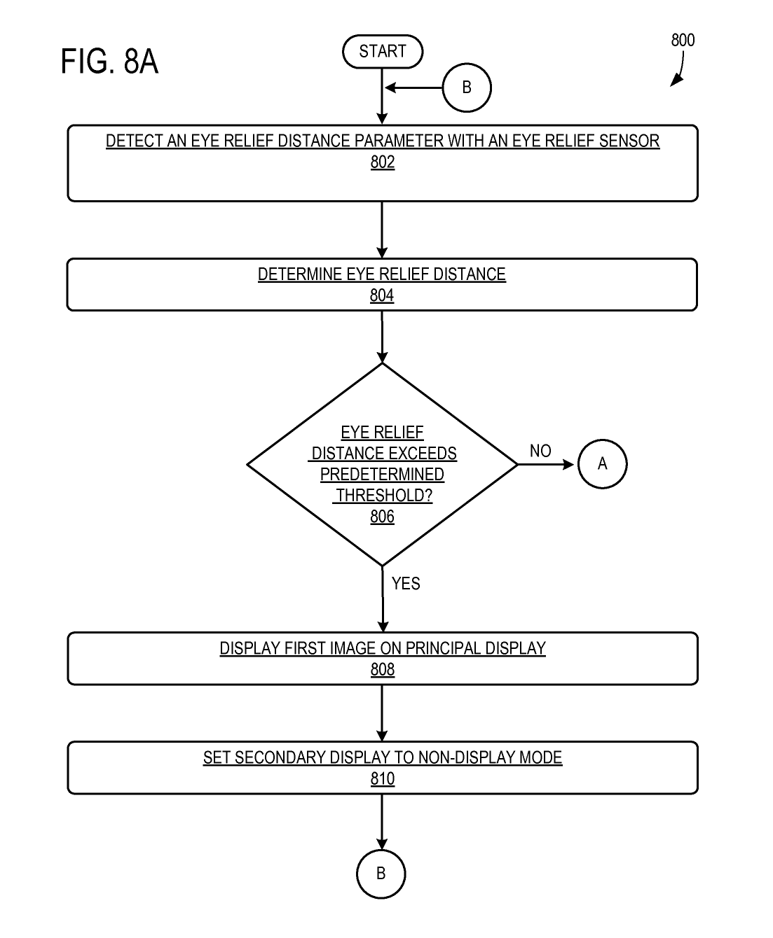

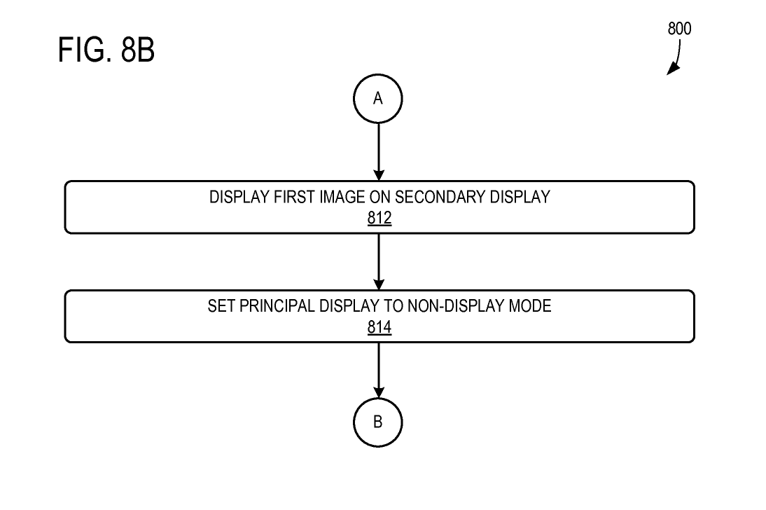

As discussed above, the multi-mode display device is configured to detect eye relief distance and select an appropriate display based upon the detected eye relief distance. FIGS. 8A and 8B are a flowchart representation of a multi-mode display method 800 for a multi-mode display device. It will be appreciated that method 800 may be implemented using the hardware components of system 10 described above, or via other suitable hardware components.

At 802, method 800 includes detecting with an eye relief sensor an eye relief distance parameter indicating an eye relief distance between a viewing surface of the multi-mode display device and an eye of the user. At 804, method 800 includes determining the eye relief distance from the eye relief distance parameter, that is, determining a value in millimeters or other units for the eye relief distance based upon the eye relief distance parameter. As discussed above, the eye relief sensor may be one or a combination of sensors 16, and the distance parameter may include any of the parameters discussed above.

At 806, method 800 includes comparing the determined eye relief distance to a predetermined threshold, which may be within the ranges discussed above. If the detected eye relief distance exceeds the predetermined threshold, method 800 proceeds to 808 where controller 22 displays a first image at a first resolution on the principal image display and at 810 sets the secondary image display to a non-display state. These steps 808, 810 may occur in this order, contemporaneously, or in the reverse order.

If the detected eye relief distance is less than the predetermined threshold, the method includes, at 812, displaying a second image at a second, higher resolution than the first resolution on a virtual plane behind the secondary image display. At 814, the method includes setting the principal image display to the non-display state. These steps 812, 814 may occur in this order, contemporaneously, or in the reverse order.

Method 800 also includes a loop function such that the eye relief distance is continuously monitored for any changes and the display mode is changed accordingly. Thus, method 800 may include changing the display of the application image from the secondary image display to the principal image display in response to a change in the detected eye relief distance between the user and the multi-mode display device from less than the predetermined eye relief distance to greater than the predetermined eye relief distance or changing the display of the application image from the principal image display to the secondary image display in response to a change in the detected eye relief distance between the user and the multi-mode display device from exceeding the predetermined eye relief distance to less than the predetermined eye relief distance.

Like system 10 above, with method 800 it will also be appreciated that the principal and secondary image displays may be configured such that the light emitted from either display passes through the same transparent region of the view surface of the housing. Further, like system 10 above, the method may be implemented by a display device that is integrated into a wristwatch. It will be appreciated that typically one of the principal image display or secondary image display that is positioned on a light emitting side of the other is transparent in the non-display state, and the one of the principal image display or secondary image display that is positioned opposite on a non-light emitting side of the other is opaque in the non-display state. However, various other configurations are possible.

FIG. 9 schematically shows a nonlimiting embodiment of a computing system 900 that may perform one or more of the above described methods and processes. Display device 14, computing device 18 and application server 40 may take the form of computing system 900. Computing system 900 is shown in simplified form. It is to be understood that virtually any computer architecture may be used without departing from the scope of this disclosure. In various embodiments, computing system 900 may be embodied in or take the form of a wristwatch, pocket watch, pendant necklace, brooch, monocle, bracelet, mobile computing device, mobile communication device, smart phone, gaming device, mainframe computer, server computer, desktop computer, laptop computer, tablet computer, home entertainment computer, network computing device, etc.

As shown in FIG. 9, computing system 900 includes a logic subsystem 904 and a storage subsystem 908. Computing system 900 may also include a display subsystem 912, a communication subsystem 916, a sensor subsystem 920, an input subsystem 922 and/or other subsystems and components not shown in FIG. 9. Computing system 900 may also include computer readable media, with the computer readable media including computer readable storage media and computer readable communication media. Further, in some embodiments the methods and processes described herein may be implemented as a computer application, computer API, computer library, and/or other computer program product in a computing system that includes one or more computers.

Logic subsystem 904 may include one or more physical devices configured to execute one or more instructions. For example, the logic subsystem 904 may be configured to execute one or more instructions that are part of one or more applications, programs, routines, libraries, objects, components, data structures, or other logical constructs. Such instructions may be implemented to perform a task, implement a data type, transform the state of one or more devices, or otherwise arrive at a desired result.

The logic subsystem 904 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 908 may include one or more physical, persistent devices configured to hold data and/or instructions executable by the logic subsystem 904 to implement the herein described methods and processes. When such methods and processes are implemented, the state of storage subsystem 908 may be transformed (e.g., to hold different data).

Storage subsystem 908 may include removable media and/or built-in devices. Storage subsystem 908 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 908 may include devices with one or more of the following characteristics: volatile, nonvolatile, dynamic, static, read/write, read-only, random access, sequential access, location addressable, file addressable, and content addressable.

In some embodiments, aspects of logic subsystem 904 and storage subsystem 908 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 9 also shows an aspect of the storage subsystem 908 in the form of removable computer readable storage media 924, which may be used to store data and/or instructions in a non-volatile manner which are executable to implement the methods and processes described herein. Removable computer-readable storage media 924 may take the form of CDs, DVDs, HD-DVDs, Blu-Ray Discs, EEPROMs, and/or floppy disks, among others.

It is to be appreciated that storage subsystem 908 includes one or more physical, persistent devices, configured to store data in a non-volatile manner. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 912 may be used to present a visual representation of data held by storage subsystem 908. As the above described methods and processes change the data held by the storage subsystem 908, and thus transform the state of the storage subsystem, the state of the display subsystem 912 may likewise be transformed to visually represent changes in the underlying data. The display subsystem 912 may include one or more display devices utilizing virtually any type of technology. Such display devices may be combined with logic subsystem 904 and/or storage subsystem 908 in a shared enclosure, or such display devices may be peripheral display devices. The display subsystem 912 may include, for example, the display device 14 shown in FIG. 1 and the displays of the various embodiments of the wearable multi-mode display system 10 described above.

When included, communication subsystem 916 may be configured to communicatively couple computing system 900 with one or more networks and/or one or more other computing devices. Communication subsystem 916 may include wired and/or wireless communication devices compatible with one or more different communication protocols. As nonlimiting examples, the communication subsystem 916 may be configured for communication via a wireless telephone network, a wireless local area network, a wired local area network, a wireless wide area network, a wired wide area network, etc. In some embodiments, the communication subsystem may allow computing system 900 to send and/or receive messages to and/or from other devices via a network such as the Internet.

Computing system 900 further comprises a sensor subsystem 920 including one or more sensors configured to sense different physical phenomenon (e.g., visible light, infrared light, sound, acceleration, orientation, position, strain, touch, etc.). Sensor subsystem 920 may be configured to provide sensor data to logic subsystem 904, for example. The sensor subsystem 920 may comprise one or more image sensors configured to acquire images facing toward and/or away from a user, motion sensors such as accelerometers that may be used to track the motion of the device, strain gauges configured to measure the strain, bend and/or shape of a wrist band, arm band, handle, or other component associated with the device, and/or any other suitable sensors. As described above, such image data, motion sensor data, strain data, and/or any other suitable sensor data may be used to perform such tasks as determining a distance between a user and the display screen of the display subsystem 912, space-stabilizing an image displayed by the display subsystem 912, etc.

When included, input subsystem 922 may comprise or interface with one or more sensors or user-input devices such as a microphone, gaze tracking system, voice recognizer, game controller, gesture input detection device, IMU, keyboard, mouse, or touch screen. In some embodiments, the input subsystem 922 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera (e.g. a time-of-flight, stereo, or structured light camera) for machine vision and/or gesture recognition; an eye or gaze tracker, accelerometer and/or gyroscope for motion detection and/or intent recognition; as well as electric-field sensing componentry for assessing brain activity.

The term “program” may be used to describe an aspect of the wearable multi-mode display system 10 that is implemented to perform one or more particular functions. In some cases, such a program may be instantiated via logic subsystem 904 executing instructions held by storage subsystem 908. It is to be understood that different programs may be instantiated from the same application, service, code block, object, library, routine, API, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-mode display device, comprising:
a housing configured with a transparent region in a viewing surface;
a principal image display mounted in the housing and configured to display a first image at a first resolution;
a secondary image display mounted in the housing and configured to display a second image of higher resolution than the first image on a virtual plane located behind the viewing surface of the display device, wherein the principal and secondary image displays are configured to alternately emit light through the transparent region in the viewing surface;
a controller configured to:
determine that a detected eye relief distance between the display device and an eye of a user is less than a predetermined threshold; and
upon determining that the eye relief distance is less than the predetermined threshold, display the second image on the secondary image display and set the principal image display to a non-display state.

2. The multi-mode display device of claim 1, wherein the principal image display is positioned on a light emitting side of the secondary image display, wherein the principal image display includes an optically transparent light emitting display and the transparent region in the viewing surface is a simple magnifier.

3. The multi-mode display device of claim 1, wherein the secondary image display is positioned on a light emitting side of the principal image display.

4. The multi-mode display device of claim 3, wherein the secondary image display includes a micro-projector and an optical waveguide configured to guide light from the micro-projector to one or more exit pupils formed close to the viewer's eye position.

5. The multi-mode display device of claim 1, further comprising a reflective polarizer and a partially-reflective, curved magnifier, wherein:
the partially-reflective, curved magnifier, reflective polarizer, and principal image display are positioned on a light emitting side of the secondary image display.

6. The multi-mode display device of claim 5, wherein the partially reflective curved magnifier is positioned to substantially collimate light emitted from the secondary image display.

7. The multi-mode display device of claim 5, wherein the partially reflective curved magnifier is positioned nearest the secondary image display compared to the reflective polarizer.

8. The multi-mode display device of claim 2, wherein the principal image display is positioned on a light emitting side of the secondary image display, wherein the light from the secondary image display is directed through an optical light path comprising one or more reflective surfaces and one or more lenses, wherein the one or more reflective surfaces and one or more lenses create a folded light path for the display of the virtual image.

9. The multi-mode display device of claim 1, further comprising an eye relief sensor configured to detect an eye relief distance parameter indicating the eye relief distance between the display device and an eye of a user.

10. The multi-mode display device of claim 9, wherein the eye relief sensor is one of a plurality of eye relief sensors selected from the group consisting of an image sensor, an ambient light sensor, an accelerometer, a strain gauge, and a capacitive touch-sensitive surface, the plurality of eye relief sensors being configured to determine the eye relief distance.

11. The multi-mode display system of claim 1, wherein the controller is further configured to:
determine that the detected eye relief distance exceeds a predetermined threshold; and
upon determining that the eye relief distance exceeds a predetermined threshold, display the first image on the principal image display and set the secondary image display to the non-display state.

12. The multi-mode display system of claim 1, wherein the housing is incorporated into a wearable computing device.

13. The multi-mode display system of claim 1, wherein the wearable computing device is a wristwatch.

14. The multi-mode display system of claim 1, wherein the one of the principal image display or secondary image display that is positioned on a light emitting side of the other is transparent in the non-display state.

15. The multi-mode display system of claim 1, wherein the one of the principal image display or secondary image display that is positioned opposite on a non-light emitting side of the other is opaque in the non-display state.

16. A multi-mode display method for a multi-mode display device comprising:
detecting an eye relief distance parameter indicating an eye relief distance between the multi-mode display device and an eye of the user;
if the detected eye relief distance exceeds a predetermined threshold, displaying a first image at a first resolution on a principal image display, the principal image display emitting light through a transparent region of a viewing surface of a housing of the multi-mode display device, and setting the secondary image display to a non-display state; and
if the distance is less than a predetermined threshold, displaying a second image at a second higher resolution and on a virtual plane behind the display on secondary image display, the secondary image display emitting light through a same transparent region of the viewing surface of the housing of the multi-mode display device, and setting the principal image display to the non-display state.

17. The method of claim 16,
wherein the one of the principal image display or secondary image display that is positioned on a light emitting side of the other is transparent in the non-display state, and
wherein the one of the principal image display or secondary image display that is positioned opposite on a non-light emitting side of the other is opaque in the non-display state.

18. The method of claim 16, wherein the principal image display and secondary image display are incorporated in a housing of the multi-mode display device that is in the form of a wearable computing device.

19. The method of claim 16, wherein the wearable computing device is a wristwatch.

20. A multi-mode display device, comprising:
a housing configured with a transparent region in a viewing surface;
a principal image display mounted in the housing and configured to display a first image at a first resolution;
a secondary image display mounted in the housing and configured to display a second image of higher resolution than the first image on a virtual plane located behind the viewing surface of the display device, wherein the principal and secondary image displays are configured to alternately emit light through the transparent region in the viewing surface;
one or more eye relief sensors configured to detect an eye relief distance parameter that indicates an eye relief distance between the display device and an eye of a user; and
a controller configured to:
determine that the detected eye relief distance exceeds a predetermined threshold;
upon determining that the eye relief distance exceeds the predetermined threshold, display the first image on the principal image display and set the secondary image display to a non-display state;
determine a change in the detected eye relief distance from exceeding the predetermined threshold to less than the predetermined threshold;
display a second image on the secondary image display and set the principal image display to a non-display state; and
determine a second change in the detected eye relief distance from less than the predetermined threshold to exceeding the predetermined threshold, set the secondary image display to the non-display state and display the first image on the principal image display.
